(19) United States
(12) Patent Application Publication
(10) Pub. No.: US 2014/0057178 A1
(43) Pub. Date: Feb. 27, 2014

(54) ANODES OF LITHIUM BATTERY

(71) Applicants: TSINGHUA UNIVERSITY, Beijing (CN); HON HAI PRECISION INDUSTRY CO., LTD., New Taipei (TW)

(72) Inventors: XING-FENG HE, Beijing (CN); YANG WU, Beijing (CN); JIA-PING WANG, Beijing (CN); KAI-LI JIANG, Beijing (CN); SHOU-SHAN FAN, Beijing (CN)

(73) Assignees: HON HAI PRECISION INDUSTRY CO., LTD., New Taipei (TW); TSINGHUA UNIVERSITY, Beijing (CN)

(21) Appl. No.: 13/869,946

(22) Filed: Apr. 24, 2013

(30) Foreign Application Priority Data
Aug. 22, 2012 (CN) 2012103003568

(51) Int. Cl. H01M 4/66

(52) U.S. Cl. CPC H01M 4/663; B82Y 30/00
USPC 429/221; 429/245; 429/218.1; 429/224; 429/223; 977/742; 977/948

(57) ABSTRACT

An anode of a lithium battery includes a carbon nanotube film structure and an anode active material. The carbon nanotube film structure includes a number of carbon nanotubes joined by van der Waals force therebetween. The anode active material is located on surface of the carbon nanotubes to form a tubular structure.

### RELATED APPLICATIONS

This application claims all benefits accruing under 35 U.S.C. §119 from China Patent Application No. 201210300356.8, filed on Aug. 22, 2012 in the China Intellectual Property Office, the disclosure of which is incorporated herein by reference. This application is related to applications entitled, “METHODS FOR FABRICATING ANODES OF LITHIUM BATTERY”, filed ______ (Atty. Docket No. US45585).

### BACKGROUND

1. Technical Field

The present invention relates to an anode of lithium battery.

2. Discussion of Related Art

In recent years, lithium batteries have received a great deal of attention. Lithium batteries are used in various portable devices, such as notebook PCs, mobile phones, and digital cameras because of their small weight, high discharge voltage, long cyclic life, and high energy density compared with conventional lead storage batteries, nickel-cadmium batteries, nickel-hydrogen batteries, and nickel-zinc batteries.

A conventional anode material is graphite anode. However, the graphite anode has low capacity property, which limits the application of the graphite anode.

What is needed, therefore, is to provide an anode of a lithium battery, which can overcome the above-described shortcomings

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a schematic structural view of one embodiment of an anode of a lithium battery.

FIG. 2 is a scanning electron microscope (SEM) image of a drawn carbon nanotube film.

FIG. 3 is an SEM image of a pressed carbon nanotube film.

FIG. 4 is an SEM image of a flocculated carbon nanotube film.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

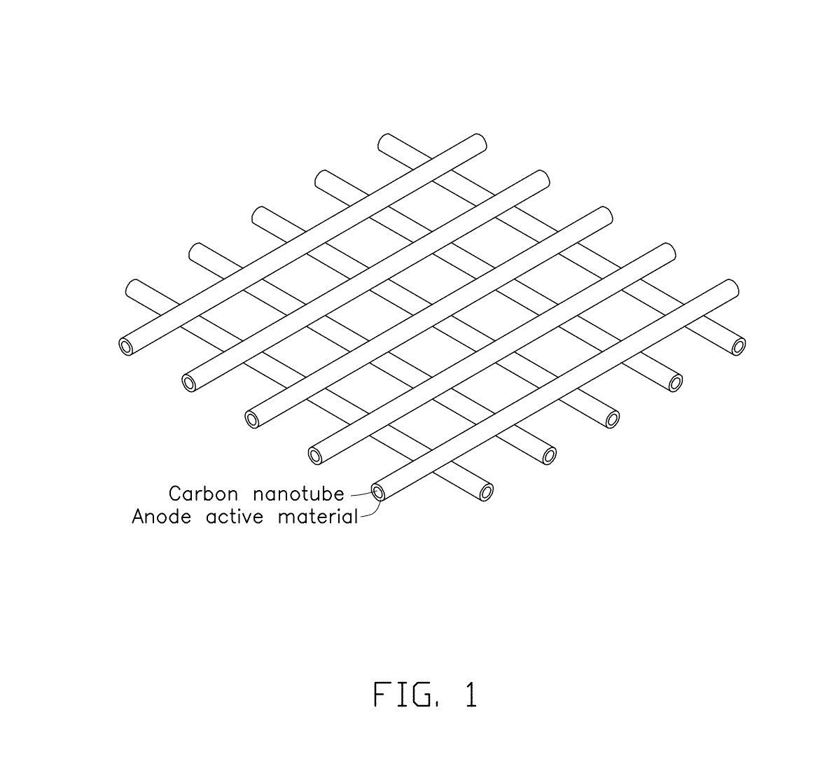

Referring to FIG. 1, an anode of a lithium battery includes a carbon nanotube film structure and an anode active material. The carbon nanotube film structure includes a plurality of carbon nanotubes. The anode active material is located on surfaces of the plurality of carbon nanotubes. A weight percentage of the anode active material in the anode of the lithium battery can range from about 50% wt to about 90% wt. In some embodiments, the weight percentage of the anode active material in the anode of the lithium battery ranges from about 70% wt to about 80% wt. In one embodiment, the weight percentage of the anode active material in the anode of the lithium battery is about 80% wt.

The carbon nanotube film structure can be a free-standing structure, that is, the carbon nanotube film structure can support itself without a substrate. For example, if at least one point of the carbon nanotube film structure is held, the entire carbon nanotube film structure can be lifted without being damaged. The carbon nanotube film structure can include a plurality of carbon nanotubes. Adjacent carbon nanotubes in the carbon nanotube film structure can be attached to each other by the van der Waals force therebetween. A plurality of micropores can be defined in the carbon nanotube film structure. A thickness of the carbon nanotube film structure can range from about 100 nanometers to about 100 micrometers. In some embodiments, the thickness of the carbon nanotube film structure ranges from about 500 nanometers to about 1 micrometer. A diameter of each of the plurality of carbon nanotubes can range from about 5 nanometers to about 20 nanometers. In some embodiments, the diameter of each of the plurality of carbon nanotubes ranges from about 10 nanometers to about 15 nanometers. In one embodiment, the diameter of each of the plurality of carbon nanotubes is about 10 nanometers. A length of the plurality of carbon nanotubes is not limited. In some embodiments, the length of the plurality of carbon nanotubes ranges from about 100 micrometers to about 900 micrometers.

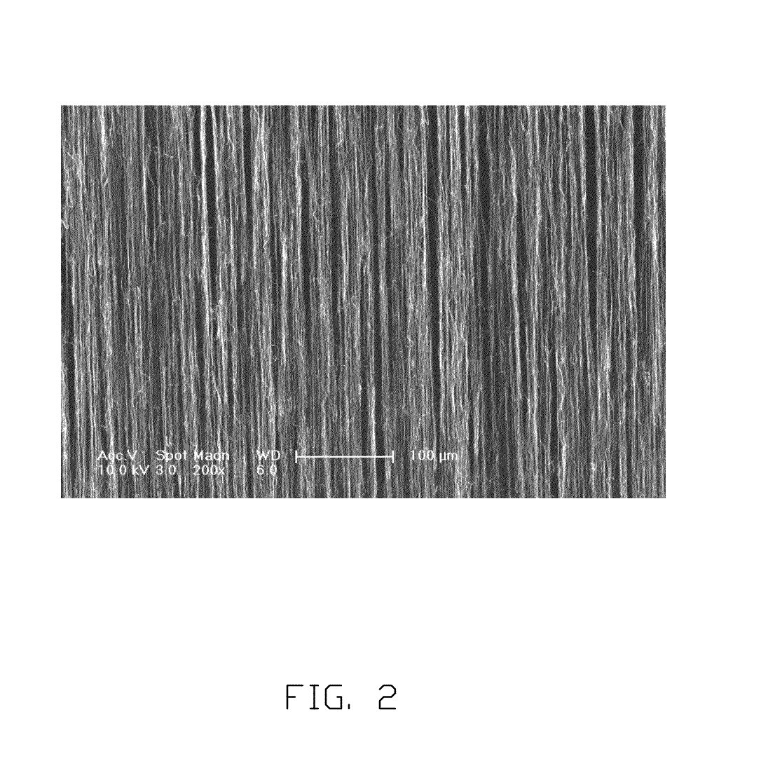

The carbon nanotube film structure can include at least one carbon nanotube film. Referring to FIG. 2, the carbon nanotube film can be a drawn carbon nanotube film formed by drawing a film from a carbon nanotube array. The drawn carbon nanotube film consists of a plurality of carbon nanotubes. The plurality of carbon nanotubes in the drawn carbon nanotube film is arranged substantially parallel to a surface of the drawn carbon nanotube film. A large number of the carbon nanotubes in the drawn carbon nanotube film can be oriented along a preferred orientation, meaning that a large number of the carbon nanotubes in the drawn carbon nanotube film are arranged substantially along a same direction. An end of one carbon nanotube is joined to another end of an adjacent carbon nanotube arranged substantially along the same direction, by van der Waals force, to form a free-standing film. A small number of the carbon nanotubes are randomly arranged in the drawn carbon nanotube film, and have a small if not negligible effect on the greater number of the carbon nanotubes in the drawn carbon nanotube film, that are arranged substantially along the same direction. It can be appreciated that some variation can occur in the orientation of the carbon nanotubes in the drawn carbon nanotube film. Microscopically, the carbon nanotubes oriented substantially along the same direction may not be perfectly aligned in a straight line, and some curved portions may exist. It can be understood that contact between some carbon nanotubes located substantially side by side and oriented along the same direction cannot be totally excluded.

The drawn carbon nanotube film includes a plurality of successively oriented carbon nanotube segments joined end-to-end by van der Waals force therebetween. Each carbon nanotube segment includes a plurality of carbon nanotubes substantially parallel to each other, and joined by van der Waals force therebetween. The carbon nanotube segments can vary in width, thickness, uniformity, and shape. The carbon nanotubes in the drawn carbon nanotube film are also substantially oriented along a preferred orientation. The width of the drawn carbon nanotube film relates to the carbon nanotube array from which the drawn carbon nanotube film is drawn. Furthermore, the carbon nanotube film has an extremely large specific surface area, and is very sticky.

The carbon nanotube film structure can include more than one stacked drawn carbon nanotube film. An angle can exist between the oriented directions of the carbon nanotubes in adjacent films. Adjacent drawn carbon nanotube films can be combined by the van der Waals force therebetween without the need of an adhesive. An angle between the oriented directions of the carbon nanotubes in two adjacent drawn carbon nanotube films can range from about 0 degree to about 90 degrees. The number of layers of the drawn carbon nanotube films in the carbon nanotube film structure is not limited. In some embodiments, the carbon nanotube film structure includes about 1 layer to 20 layers of stacked drawn carbon nanotube films. In one embodiment, the carbon nanotube film structure includes 2 layers of stacked drawn carbon nanotube films, and the angle between the oriented directions of the carbon nanotubes of the two drawn carbon nanotube films is about 90 degrees.

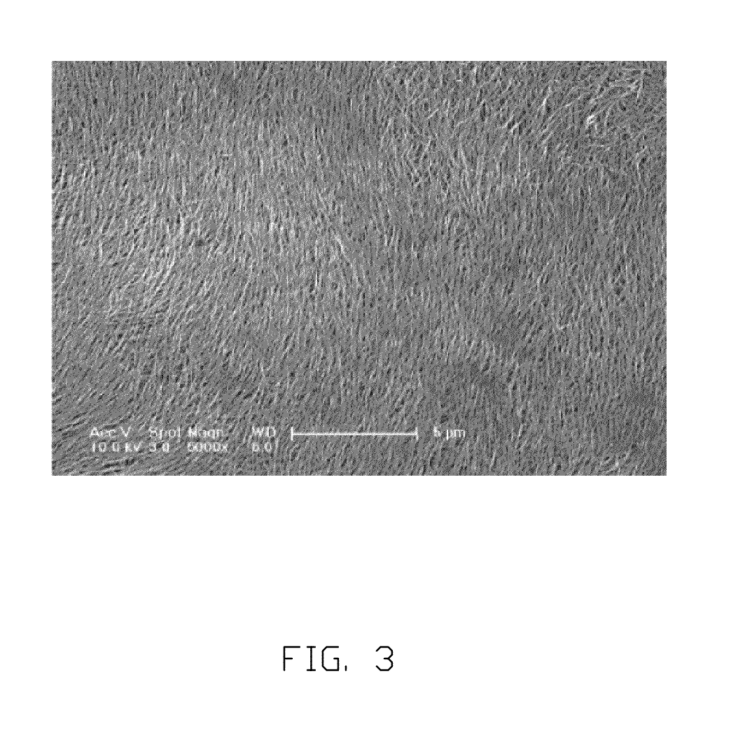

Referring to FIG. 3, the carbon nanotube film can also be a pressed carbon nanotube film formed by pressing a carbon nanotube array down on the substrate. The carbon nanotubes in the pressed carbon nanotube array can be arranged along a same direction or along different directions. The carbon nanotubes in the pressed carbon nanotube array can rest upon each other. Some of the carbon nanotubes in the pressed carbon nanotube film can protrude from a general surface/plane of the pressed carbon nanotube film. Adjacent carbon nanotubes are attracted to each other and combined by van der Waals force. When the carbon nanotubes in the pressed carbon nanotube array are arranged along different directions, the carbon nanotube structure can be isotropic.

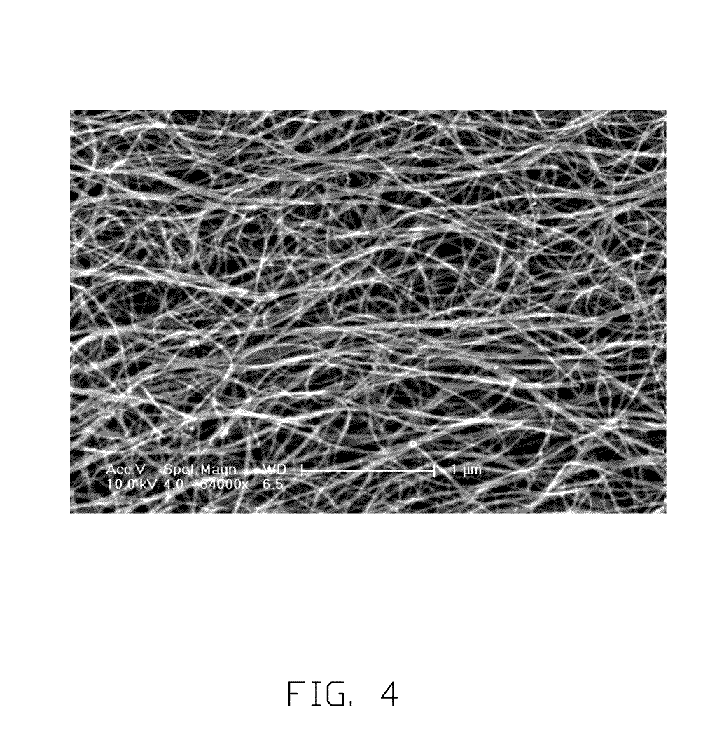

Referring to FIG. 4, the carbon nanotube film can also be a flocculated carbon nanotube film formed by a flocculating method. The flocculated carbon nanotube film can include a plurality of long, curved, disordered carbon nanotubes entangled with each other. The carbon nanotubes can be substantially uniformly distributed in the carbon nanotube film. The adjacent carbon nanotubes are acted upon by the van der Waals force therebetween. Some of the carbon nanotubes in the flocculated carbon nanotube film can protrude from a general surface/plane of flocculated carbon nanotube film.

In some embodiments, the anode active material is uniformly coated on entire surface of each carbon nanotube to form a successive tubular structure. A thickness of tubular structure can be selected according to the diameter of the plurality of carbon nanotubes. This is because, with the increase of the thickness of the tubular structure, the anode of the lithium battery can have higher capacity; however, the ion/electron transport rate of the anode of the lithium battery can be decreased. Thus, the thickness of the tubular structure should be controlled in order to optimize the performance of the anode of the lithium battery. The thickness of the tubular structure can be 0.5-3 times greater than the diameter of the plurality of carbon nanotubes. In some embodiments, the thickness of the tubular structure is about 1-2 times greater than the diameter of the plurality of carbon nanotubes. In one embodiment, the thickness of the tubular structure is substantially equal to the diameter of the plurality of carbon nanotubes.

It is to be noted that, when the diameter of each of the plurality of the carbon nanotubes is less than 5 nanometers, the anode active material cannot be uniformly deposited on surface of each carbon nanotube to form the tubular structure, because of a great curvature of the plurality of the carbon nanotubes. Thus, the performance of the anode of the lithium battery can be decreased. Furthermore, when the diameter of each of the plurality of the carbon nanotubes is greater than 20 nanometers, it would be difficult to improve the capacity of the anode of the lithium batter by increasing the thickness of the tubular structure. Because when the thickness of the tubular structure is greater than 60 nanometers, the ion/electron transport rate of the anode of the lithium batter can be rapidly increased.

The anode active material can be nonmetal element or metal oxide. The nonmetal element can be silicon, sulfur, or their combination. In some embodiments, the anode active material is transition metal oxide, such as oxide of tin, oxide of iron, oxide of cobalt, oxide of manganese, oxide of nickel, or their combination. In one embodiment, the anode active material is Co₃O₄, and a capacity of the anode of the lithium battery is about 2-3 times greater than a capacity of graphite anode.

The anode of the lithium battery of the present embodiment has the following advantages. First, the anode active material can be uniformly coated on surface of each carbon nanotube without aggregation, as such, a stable anode of the lithium battery with high conductivity can be obtained. Second, the capacity of the anode of the lithium battery can be increased due to a great specific surface area of carbon nanotube which can be used to support a great amount of the anode active material. Third, during the use of the anode active material, the lithium ion can be inserted into the micropores of the carbon nanotube film structure, thus, a volume of the anode active material can remain unchanged to obtain a more stable anode of the lithium battery. Fourth, the capacity and ion/electron transport rate of the anode of the lithium battery can be improved due to the optimize thickness of the tubular structure according to the diameter of the plurality of carbon nanotubes. Additionally, the anode of the lithium battery is a thin film structure, and can be easily used in different kinds of portable electronic apparatuses.

The above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

1. An anode of a lithium battery comprising:
a carbon nanotube film structure comprising a plurality of carbon nanotubes joined by van der Waals force therebetween; and
an anode active material located on surfaces of the plurality of carbon nanotubes to form a plurality of tubular structures of the anode active material.

2. The anode of the lithium battery of claim 1, wherein the anode active material is uniformly coated on entire surface of each carbon nanotube to form the plurality of tubular structures of the anode active material.

3. The anode of the lithium battery of claim 1, wherein a diameter of each of the plurality of carbon nanotubes ranges from about 5 nanometers to about 20 nanometers.

4. The anode of the lithium battery of claim 3, wherein the diameter of each of the plurality of carbon nanotube ranges from about 10 nanometers to about 15 nanometers.

5. The anode of the lithium battery of claim 3, wherein a thickness of the tubular structure is about 0.5-3 times greater than the diameter of the plurality of carbon nanotubes.

6. The anode of the lithium battery of claim 5, wherein a thickness of the tubular structure is about 1-2 times greater than the diameter of the plurality of carbon nanotubes.

7. The anode of the lithium battery of claim 6, wherein a thickness of the tubular structure is substantially equal to the diameter of the plurality of carbon nanotubes.

8. The anode of the lithium battery of claim 1, wherein a weight percentage of the anode active material ranges from about 50% wt to about 90% wt.

9. The anode of the lithium battery of claim 8, wherein the weight percentage of the anode active material in the anode of the lithium battery ranges from about 70% wt to about 80% wt.

10. The anode of the lithium battery of claim 1, wherein the carbon nanotube film structure comprises at least two overlapped carbon nanotube films.

11. The anode of the lithium battery of claim 10, wherein each carbon nanotube film consists of the plurality of carbon nanotubes arranged substantially along a same direction.

12. The anode of the lithium battery of claim 11, wherein an end of each carbon nanotube is joined to another end of an adjacent carbon nanotube along an arranged direction by van der Waals force.

13. The anode of the lithium battery of claim 10, wherein each carbon nanotube film consists of the plurality of carbon nanotubes entangled with each other.

14. The anode of the lithium battery of claim 10, wherein each carbon nanotube film consists of the plurality of carbon nanotubes rested upon with each other and arranged along a same direction.

15. The anode of the lithium battery of claim 1, wherein the anode active material comprises a material selected from the group consisting of silicon, sulfur and their combination.

16. The anode of the lithium battery of claim 1, wherein the anode active material comprises a material selected from the group consisting of oxide of tin, oxide of iron, oxide of cobalt, oxide of manganese, oxide of nickel, and their combination.

17. An anode of a lithium battery comprising:
a carbon nanotube film structure comprising a plurality of carbon nanotubes joined by van der Waals force therebetween to form a free-standing structure; and
an anode active material located on surface of each carbon nanotube to form a tubular structure of the anode active material.

18. The anode of the lithium battery of claim 17, wherein a diameter of each of the plurality of carbon nanotube ranges from about 10 nanometers to about 15 nanometers.

19. The anode of the lithium battery of claim 18, wherein a thickness of the tubular structure is about 1-2 times greater than the diameter of the plurality of carbon nanotubes.

20. The anode of the lithium battery of claim 17, wherein a weight percentage of the anode active material ranges from about 70% wt to about 80% wt.
